(19) United States
(12) Patent Application Publication
(10) Pub. No.: US 2004/0150183 A1
(43) Pub. Date: Aug. 5, 2004

(54) Vehicle running board assembly

(76) Inventors: Daniel Clermont, Windsor (CA); Ross Vincent, Tecumseh (CA)

Correspondence Address: Miller, Canfield, Paddock and Stone P.L.C., c/o Robert Kelley Roth, Suite 2500, 150 West Jefferson Ave, Detroit, MI, 48226, US

(21) Appl. No.: 10/357,020

(22) Filed: Feb. 3, 2003

(51) Int. Cl. B60R 3/00

(52) U.S. Cl. 280/163

(57) ABSTRACT

A vehicle running board assembly comprises a pipe adapted to be connected to a motor vehicle, the pipe having an interior surface and first and second side edges defining an opening, a step pad having a contact surface contacting the first and second side edges, and a clip connected to the step pad, extending into the opening and resiliently engaging the pipe so as to resist separation of the clip and step pad from the pipe. A load is defined by the weight of the step pad and any other object on the step pad. The step pad contact surface directly contacts the first and second side edges of the pipe so that the side edges act as primary bearing surfaces for the load. The clip may have a series of retaining ribs where each of the retaining ribs are resiliently flexible around a single axis and engage the interior surface of the pipe below the single axis.

### FIELD OF THE INVENTION

This invention relates to vehicle running board assemblies, and, more particularly, to vehicle running board assemblies used on sport utility vehicles and pickup trucks.

### BACKGROUND OF THE INVENTION

Vehicle running board assemblies are used on large vehicles such as pickup trucks and sport utility vehicles (“SUVs”) and the like to allow individuals to step up to enter the vehicle. Generally known designs for vehicle running boards have had some sort of pipe, typically metal, attached to the motor vehicle with a suitable attachment mechanism. A step pad, generally formed of some sort of rubber-like material would then be attached to the pipe in one of various ways. The step pad often has a ribbed or corrugated exterior or show surface which would help a person maintain traction as he stepped onto the step pad and into the vehicle. Older designs generally would cut away a portion of the pipe and use a load transmitting member which would rest on the bottom of the interior of the pipe, and the step pad would then fit over this load transmitting member and close the opening.

One example of an attempt to develop a low cost design for vehicle running board assemblies is taught in U.S. Pat. No. 5,713,589 to Delgado et al. Delgado et al discloses a step and an insert which transmits load down to the bottom of the interior of the pipe through a pipe opening. In order to clear the opening formed in a pipe, the insert is inserted into the pipe opening and then rotated 90 degrees into its final position. Clearly, this makes for somewhat awkward assembly of the various components. Consequently, other designs have been developed to simplify such assembly.

U.S. Pat. No. 6,409,193 and 6,173,979 to Bernard teach a step pad having a support plate connected to the step pad by snap fit. The support plate acts as the primary load bearing element on the pipe, directly contacting the pipe at side edges of a pipe opening. V-shaped retaining ribs on the support engage an interior surface of the pipe. The step pad is shown to make sealing contact with the pipe, but is not designed to be a load bearing element. This design is advantageous in that it permits a straight drop assembly method, without need for relying on a rotational insertion. However, it would be desirable to improve material usage so that as little of the materials of the step pad and support be used as is possible. It would also be desirable to enhance the retaining force of the retaining ribs, to avoid a retaining rib which deflects about a pair of axes in response to a dislocation force, and it would be desirable to provide a vehicle running board assembly of a low cost design which reduces buzz, squeaks and rattles.

### SUMMARY OF THE INVENTION

In accordance with a first aspect, a vehicle running board assembly comprises a pipe adapted to be connected to a motor vehicle, and the pipe has an interior surface and first and second side edges defining an opening. A step pad has a contact surface contacting the first and second side edges, and a clip is connected to the step pad, and extends into the opening to resiliently engage the pipe and thereby resist separation of the clip and step pad from the pipe. A load comprises at least a weight of the step pad, and the step pad contact surface directly contacts the first and second side edges of the pipe so that the side edges act as primary bearing surfaces for the load.

In accordance with another aspect, the clip has a row of resiliently deformable retaining ribs, wherein each of the retaining ribs are resiliently flexible around a single axis and engage the interior surface of the pipe below the single axis.

From the foregoing disclosure and the following more detailed description of various preferred embodiments it will be apparent to those skilled in the art that the present invention provides a significant advance in the technology and art of vehicle running board assemblies. Particularly significant in this regard is the potential the invention affords for providing a high quality, low cost, running board assembly which reduces problems with vibration and noises. Additional features and advantages of various preferred embodiments will be better understood in view of the detailed description provided below.

### BRIEF DESCRIPTION OF THE DRAWINGS

FIG. 1 is a perspective view of an representative SUV having a running board assembly in accordance with a preferred embodiment, showing a pair of steps.

FIG. 2 is fragmentary perspective view showing the step in assembled position in the pipe.

FIG. 3 is an exploded perspective view of the components of a preferred embodiment.

FIG. 4 is an underside isolated perspective view of the step pad of FIG. 3.

FIG. 5 is an underside perspective view of the preferred embodiment of FIG. 3 with the step pad and clip assembled together.

FIG. 6 is an underside perspective view of the preferred embodiment of FIG. 3 showing the pipe partially cut away and fingers on the clip engaging the pipe.

FIG. 7 is a cross section view of the running board assembly of FIG. 3, showing the step pad with principal load bearing on the pipe opening edges.

FIG. 8 is a cross section view of the pipe in accordance with a preferred embodiment, showing an extraction force exerted on the step pad, and retaining ribs which are resiliently flexible around a single axis and engage the interior surface of the pipe below the single axis.

FIG. 9 is a cross section view of an alternate preferred embodiment where the clip has been eliminated and the step pad is retained to the pipe with a retainer tree feature formed on the brackets at the ends of the step pad.

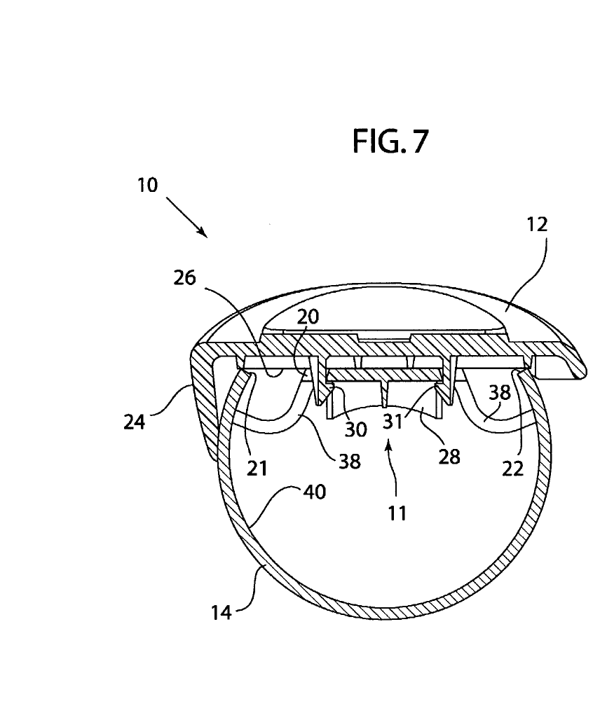

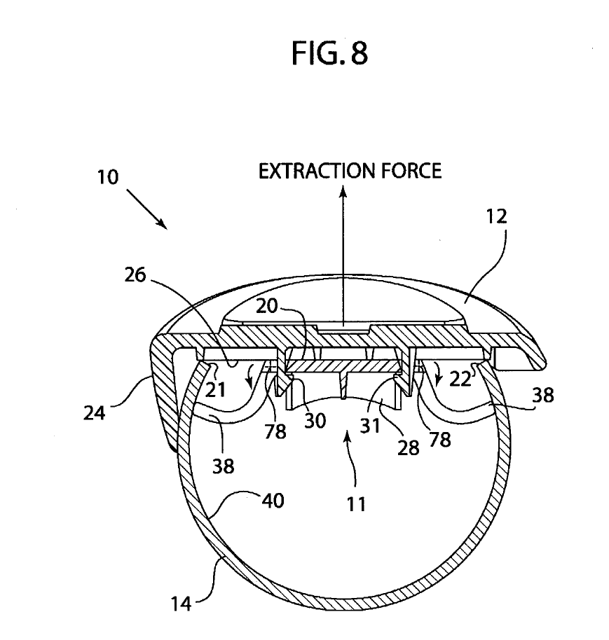

It should be understood that the appended drawings are not necessarily to scale, presenting a somewhat simplified representation of various preferred features illustrative of the basic principles of the invention. The specific design features of the vehicle running board assembly as disclosed here, including, for example, the specific dimensions of the step pad, will be determined in part by the particular intended application and use environment. Certain features of the illustrated embodiments have been enlarged or distorted relative to others to facilitate visualization and clear understanding. In particular, thin features may be thickened, for example, for clarity of illustration. All references to direction and position, unless otherwise indicated, refer to the orientation illustrated in the drawings. “Up, upward, above and downward or below” refers to the orientation of FIGS. 7 and 8 in the paper.

### DETAILED DESCRIPTION OF CERTAIN PREFERRED EMBODIMENTS

It will be apparent to those skilled in the art, that is, to those who have knowledge or experience in this area of technology, that many uses and design variations are possible for the vehicle running board assembly disclosed here. The following detailed discussion of various alternative and preferred features and embodiments will illustrate the general principles of the invention with reference to a vehicle running board assembly suitable for use with a sport utility vehicle. Other embodiments suitable for other applications will be readily apparent to those skilled in the art given the benefit of this disclosure.

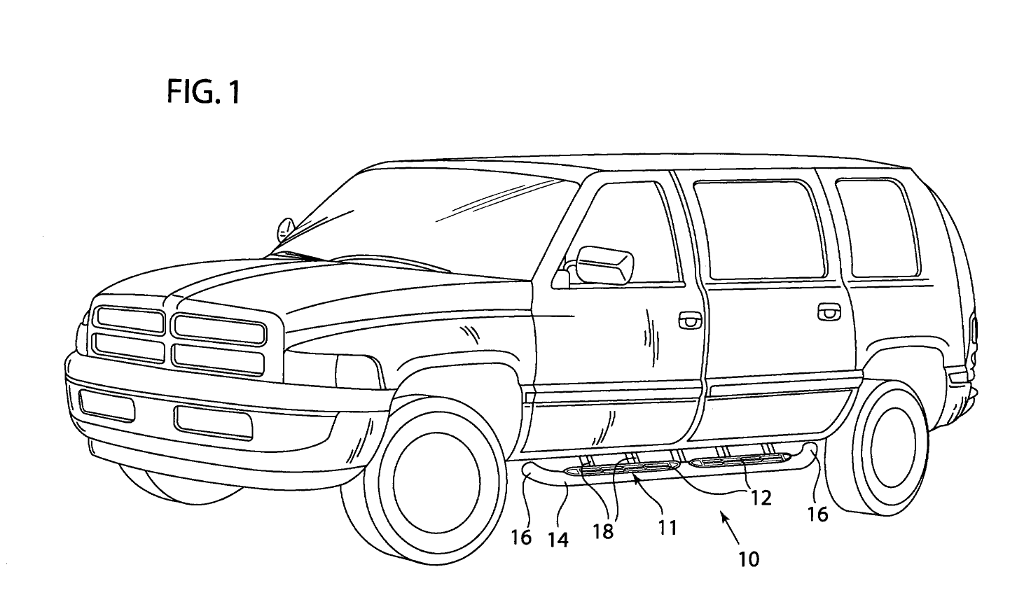

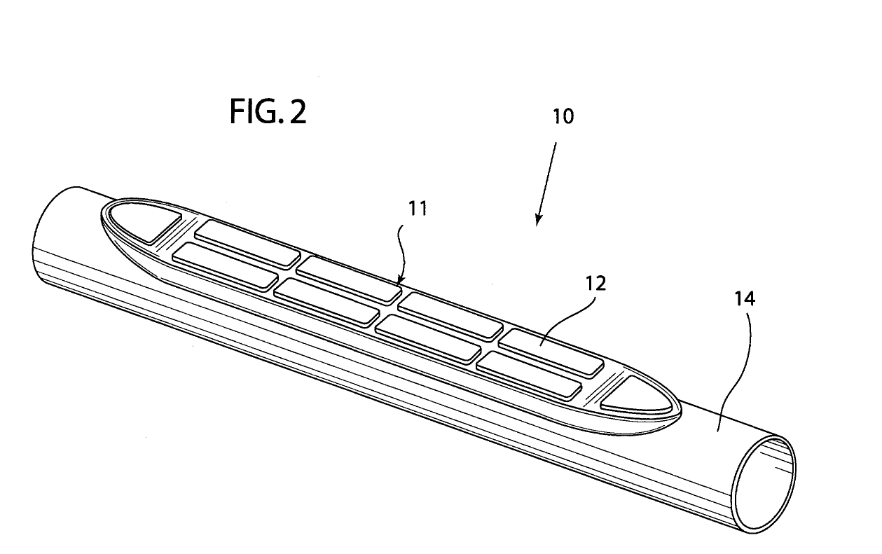

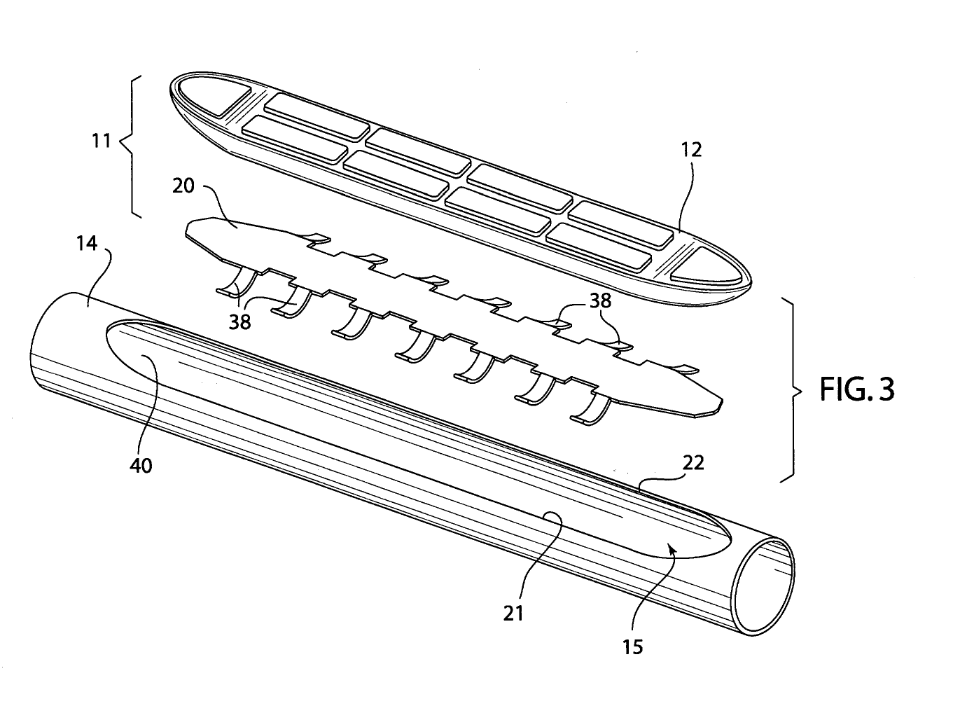

Referring now to the drawings, in FIGS. 1-2 show a vehicle running board assembly 10 comprising a step 11 and pipe 14. The pipe is connected to a motor vehicle through a series of connectors 18. In accordance with a highly advantageous styling feature, the connectors can be attached to the motor vehicle remote from the ends 16 of pipe. The step 11 comprises at least one step pad 12 and may also have a clip 20 or supporting element underneath as shown in FIG. 3. The vehicle running board assembly may have a pair of step pads 12, as shown in FIG. 1, with a ridged or corrugated show surface to enhance step contact (best shown in FIG. 2.) An opening 15 is cut in the pipe 14, defined by side edges 21, 22. The clip 20 is shown in FIG. 3 to extend generally along and underneath the step pad and fit into the opening 15. Retaining ribs 38 engage the interior surface 40 of the pipe, resisting dislocation of the clip 20 and step pad 12 from the pipe.

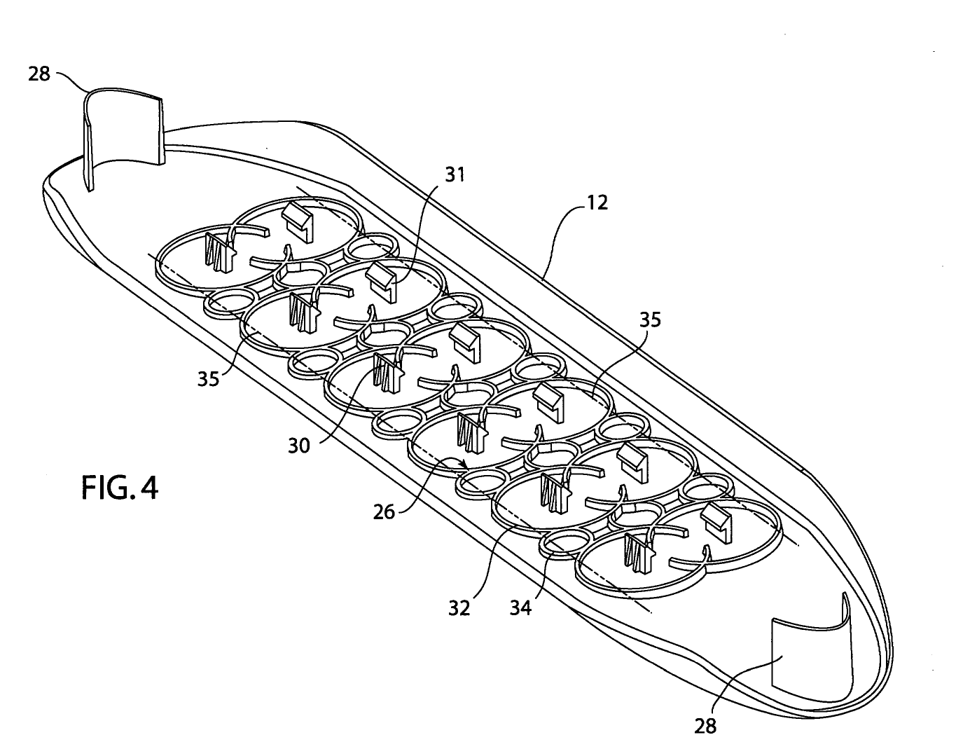

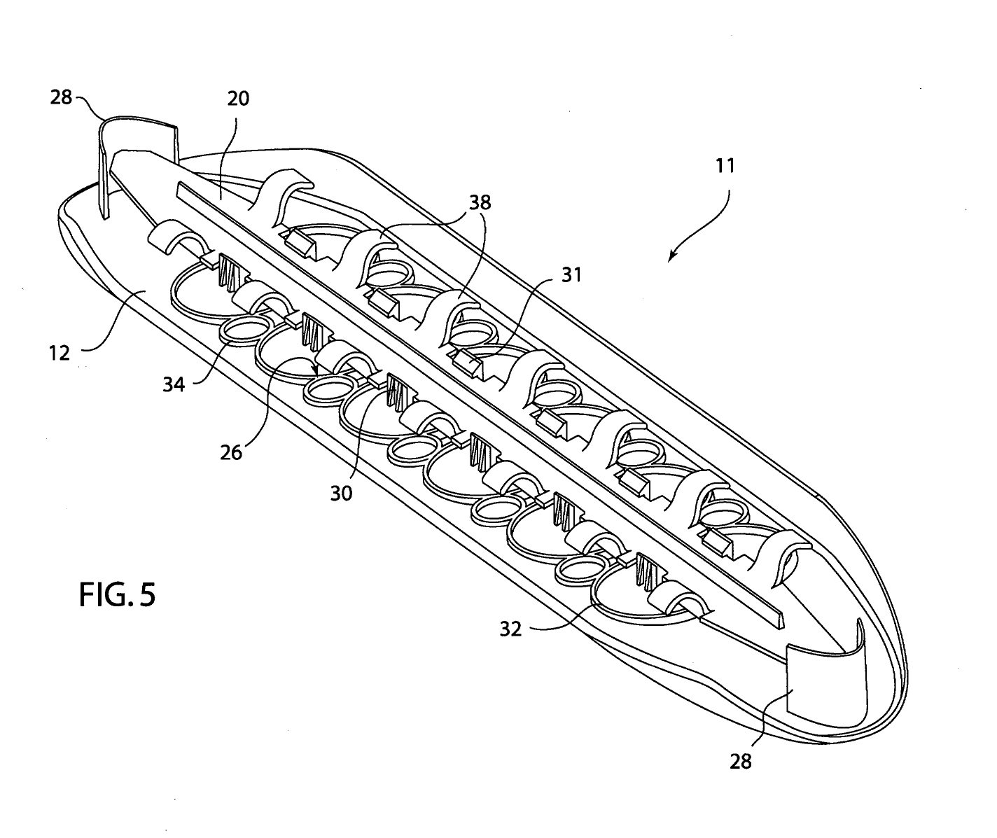

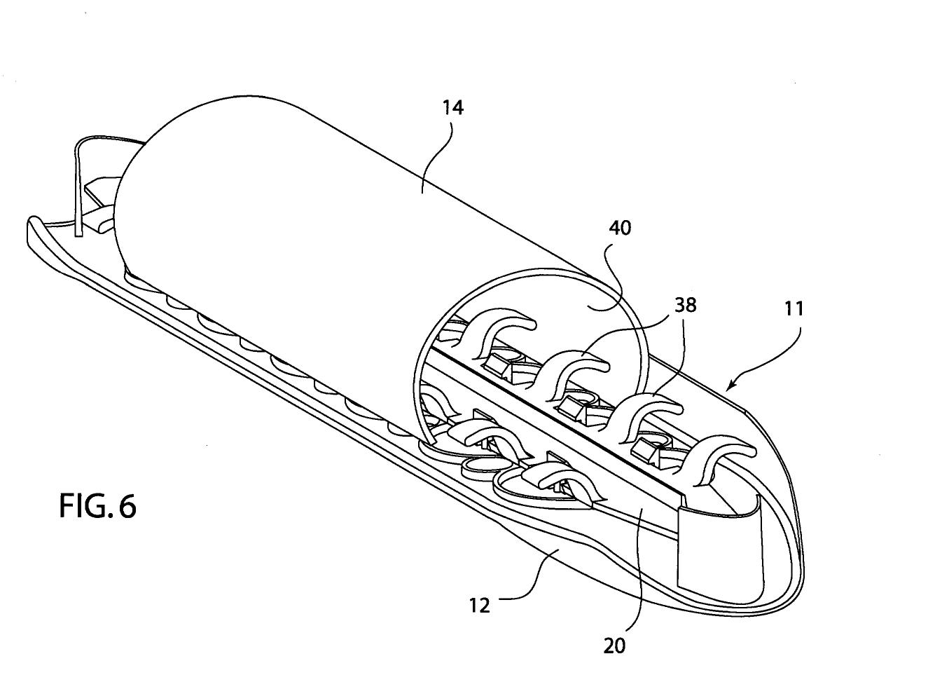

FIGS. 4-6 show underside perspective views of the step pad 12 (FIG. 4), clip 20 and step pad 12 (FIG. 5) and pipe 14, clip 20 and step pad 12 (FIG. 6). End fingers 36 cooperate with rows of fingers or flanges 30, 31 to secure the step pad to the clip 20. See FIG. 5. Preferably the fingers 30, 31 are resiliently deformable so that they can be assembled to the clip by snap fit. Side brackets 28 can serve as guides and alignment elements, and may also help resist separation of the clip from the step pad. A spacing element 26 may be formed from the step pad, helping to ensure proper alignment of the step pad with respect to the pipe 14. The spacing element is shown here to comprise a series of projections or ribs extending downward from the step pad 12. In the preferred embodiment shown in FIG. 4, the spacing element 26 comprises a series of nearly circular arc segments 32, two rows of six each, with each row intersecting the other, and a series of smaller complete circles 34, three rows of five, interspersed between the arc segments 32. Preferably the contact surfaces 35 that the pipe 14 makes with the step pad 12 extend across both the arc segments 32 and the circles 34. Other geometries for the spacing element will be readily apparent to those skilled in the art given the benefit of this disclosure. In FIG. 6, a portion of the pipe 14 is added to show its position with respect to the step pad and clip. Rows of retaining ribs 38 biasingly engage the interior surface 40 of the pipe 14.

Preferably the side brackets 28 and spacing element 26 arc segments 32 and full circles 34 are all formed as unitary extensions of the step pad. That is, all of these elements are made together with the step pad of a one-piece construction, preferably by injection molding.

FIG. 7 is a cross section view showing the assembled vehicle running board assembly. A side remote from the vehicle may optionally have a show surface side flange 24 to hide the pipe opening and the clip 20. The ribs 38 are seen to be arcuate shaped unitary extensions of the clip and resiliently engage the interior 40 of the pipe generally adjacent the pipe opening. Step pad 12 transmits a load from its underside contact surface to the side edges 21,22 of the pipe 14. The load would comprise, for example, a weight of the step pad, as well as the weight of any object on the step pad such as a person stepping on the step pad. In accordance with a highly advantageous feature, the side edges 21, 22 act as primary bearing surfaces receiving the load. That is, the side edges act to receive the vast majority of all forces transmitted by the act of stepping on the step pad.

The side edges 21, 22 of the pipe define a first width and the clip retaining ribs 38 have a second width which when undeflected exceeds the first width. In accordance with another highly advantageous feature, the arcuate retaining ribs 38 are resiliently flexible so that they can bend past the side edges 21, 22 during insertion into the pipe opening, then deflect back against the interior surface upon clearing the side edges. The ribs are deflectable about their bases at pivot axes 78. That is, the ribs only pivot about a single axis 78. In accordance with another highly advantageous feature, the retaining ribs 38 engage the interior surface 40 of the pipe below the single axis 78 as shown in FIG. 8. Therefore, in response to an extraction or separation force, the moment on the ribs would tend to urge the ribs against the direction of the separation force.

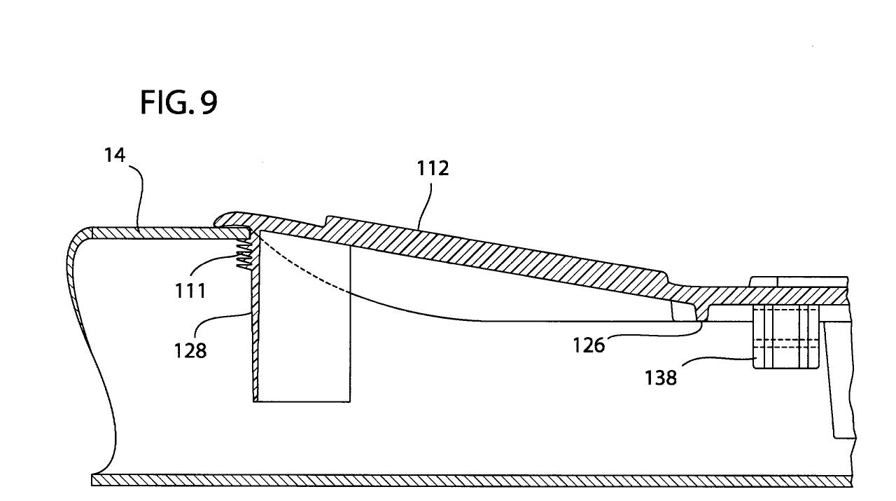

FIG. 9 shows an alternate preferred embodiment where the clip has been removed, retaining ribs 138 are formed as unitary extensions of the step pad 112 and tree retainers 111 are formed in the step pad to help secure the step pad to the pipe 14. Step pad may be provided with spacing elements 126, if necessary. The tree retainers 111 may preferably be formed as unitary projections of the side brackets 128, one at each end of the step pad 111. The tree retainers deflect pas the pipe edge during assembly and cooperate with the retaining ribs to resist separation of the step pad from the pipe.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A vehicle running board assembly comprising, in combination:
a pipe adapted to be connected to a motor vehicle, the pipe having an interior surface and first and second side edges defining an opening;
a step pad having a contact surface contacting the first and second side edges;
a clip connected to the step pad, extending into the opening and resiliently engaging the pipe so as to resist separation of the clip and step pad from the pipe;
a load, comprising at least a weight of the step pad;
wherein the step pad contact surface directly contacts the first and second side edges of the pipe so that the side edges act as primary bearing surfaces for the load.

2. The vehicle running board assembly of claim 1 wherein the contact surface of the step pad is formed as a spacing element.

3. The vehicle running board assembly of claim 2 wherein the spacing element comprises a series of projections formed unitary with the step pad.

4. The vehicle running board assembly of claim 3 wherein the series of projections comprises at least one projection formed as an arc segment and at least one projection formed a as circle.

5. The vehicle running board assembly of claim 1 wherein the pipe opening has a first width and the clip has a second width, and the second width exceeds the first width.

6. The vehicle running board assembly of claim 1 wherein the clip has retaining ribs which biasingly engage the interior surface of the pipe and resist separation of the clip from the pipe.

7. The vehicle running board assembly of claim 1 wherein the step pad and clip are connected by snap fit.

8. A vehicle running board assembly comprising, in combination:
a pipe adapted to be connected to a motor vehicle, the pipe having an interior surface and first and second side edges forming an opening;
a step pad covering the opening; and
a row of resiliently deformable retaining ribs resisting separation of the step pad from the pipe; wherein each of the retaining ribs are resiliently flexible around a single axis and engage the interior surface of the pipe below the single axis.

9. The vehicle running board assembly of claim 8 wherein the retaining ribs are arcuate shaped.

10. The vehicle running board assembly of claim 8 wherein the retaining ribs are formed as unitary extensions of a clip which is connected to the step pad.

11. The vehicle running board assembly of claim 10 wherein the pipe opening has a first width and the clip has a second width which exceeds the first width.

12. A vehicle running board assembly comprising, in combination:
a pipe adapted to be connected to a motor vehicle, the pipe having first and second side edges defining an opening and having an interior surface;
a step pad having a show surface and a contact surface, a first end and a second end opposite the first end with a bracket formed at each end, and a tree retainer positioned on each bracket; and
a row of resilient retaining ribs formed as a unitary extension of the step pad which extend into the opening and engage the interior surface of the pipe, wherein the tree retainer and the retaining ribs engage the pipe to resist separation of the step pad from the pipe.

13. The vehicle running board assembly of claim 12 further comprising
a load, comprising at least a weight of the step pad;
wherein the step pad contact surface directly contacts the first and second side edges of the pipe so that the side edges act as primary bearing surfaces for the load.

14. The vehicle running board assembly of claim 12 wherein each of the retaining ribs are resiliently flexible around a single axis and engage the interior surface of the pipe below the single axis.
